(19) United States
(12) Patent Application Publication
(10) Pub. No.: US 2016/0314257 A1
(43) Pub. Date: Oct. 27, 2016

(54) SCHEDULING DEVICE FOR SCHEDULING PATIENT MONITORING BY PATIENT-ACCESSIBLE DEVICES

(71) Applicant: KONINKLIJKE PHILIPS N.V., Eindhoven (NL)

(72) Inventors: Julian Charles NOLAN, Pully (CH); Melanie Jane WINDRIDGE, Amersham (NL); Matthew John LAWRENSON, Bussigny-pres-de-lausanne (CH); Cees VAN BERKEL, Hove (GB)

(21) Appl. No.: 15/105,606

(22) PCT Filed: Dec. 15, 2014
(86) PCT No.: PCT/EP2014/077663

§ 371 Date: Jun. 17, 2016

(30) Foreign Application Priority Data
Dec. 20, 2013 (EP) 13198858.6

(51) Int. Cl. G06F 19/00; G06F 17/30

(52) U.S. Cl. CPC G06F 19/3406; G06F 19/345; G06F 17/3053; G06F 17/30598

(57) ABSTRACT

The present invention relates to a scheduling device (10, 10a, 10b) for scheduling patient monitoring by patient-accessible devices that are in the possession or reach of the patient for use by the patient. To enable unobtrusive patient monitoring that is more in line with patient's usage habits and causes less or no disruptions, the scheduling device comprises a diagnostics input (11) for receiving diagnostics, said diagnostics input (11) including a monitoring time window for acquiring data required by or useful for the diagnostics, a device identification unit (12) for identifying patient-accessible devices suitable for acquiring data required by or useful for the diagnostics, a tracking unit (13) for tracking one or more of the identified patient-accessible devices to identify their usage, and a controller (15) for checking, during said monitoring time window, availability of identified patient-accessible devices for data acquisition and for controlling available patient-accessible devices to acquire data required by or useful for the diagnostics during said monitoring time window.

### FIELD OF THE INVENTION

The present invention relates to a scheduling device and a corresponding method for scheduling patient monitoring by patient-accessible devices. Further, the present invention relates to a computer program for implementing said scheduling method and to a system for patient monitoring.

### BACKGROUND OF THE INVENTION

The convergence of increasing connectivity with the increasing use of sensors is now making research areas such as sensor networks a reality. A wide variety of networked sensors are also finding their way into health applications, as e.g. described in “Everything in medicine is going mobile (HIMSS meeting)” by Pamela Lewis Dolan, currently published at http://www.amednews.com/article/20120326/business/303269972/4/.

US 2012/324470 A1 discloses a system and method for scheduling resources including a memory storage device having a resource data structure stored therein which is configured to store a collection of available resources, time slots for employing the resources, dependencies between the available resources and social map information. A processing system is configured to set up a communication channel between users, between a resource owner and a user or between resource owners to schedule users in the time slots for the available resources. The processing system employs social mapping information of the users or owners to assist in filtering the users and owners and initiating negotiations for the available resources.

Patients with medical conditions or risks, such as the elderly, will need monitoring that relies on taking regular diagnostic samples. This could be regarded as a chore unless the monitoring could be incorporated into daily lives.

US 2009/0182575A1 discloses a system and method to manage progression of patients through a workflow of events that employs at least one resource in delivering healthcare. The system comprises a sensor operable to track at least one property of the plurality of patients, and at least one processor in communication with the sensor. The processor is operable to execute computer readable program instructions generally representative of the steps of calculating a bid of the more than one of series of resources relative to one another directed to a slot in the schedule of workflow of the patient dependent on tracked properties of the resources, and assigning one the resources to the slot in the schedule of workflow of the least one patient dependent on a comparison of the bid of the resources relative to one another.

US 2003/0036683 A1 discloses a method, system and computer program product for an internet-enabled patient monitoring system.

### SUMMARY OF THE INVENTION

It is an object of the present invention to provide a scheduling device and a corresponding method for scheduling patient monitoring by patient-accessible devices, which enables unobtrusive patient monitoring that is more in line with patient's usage habits and causes less or no disruptions. Further, it is an object of the present invention to provide a computer program for implementing said scheduling method and a system for patient monitoring.

In a first aspect of the present invention a scheduling device for scheduling patient monitoring by patient-accessible devices that are in the possession or reach of the patient for use by the patient is presented comprising

a diagnostics input for receiving diagnostics, said diagnostics input including a monitoring time window for acquiring data required by or useful for the diagnostics,

a device identification unit for identifying patient-accessible devices suitable for acquiring data required by or useful for the diagnostics,

a tracking unit for tracking one or more of the identified patient-accessible devices to identify their usage, and

a controller for checking, during said monitoring time window, availability of identified patient-accessible devices for data acquisition and for controlling available patient-accessible devices to acquire data required by or useful for the diagnostics during said monitoring time window.

In a further aspect of the present invention a system for patient monitoring is presented comprising

a scheduling device as disclosed herein for scheduling patient monitoring by patient-accessible devices,

one or more patient-accessible devices for acquiring data required by or useful for diagnostics required for patient monitoring as scheduled by said scheduling device, and

a data processor for processing data acquired by said one or more patient-accessible devices.

In yet further aspects of the present invention, there are provided a corresponding scheduling method, a computer program which comprises program code means for causing a computer to perform the steps of the scheduling method disclosed herein when said computer program is carried out on a computer as well as a non-transitory computer-readable recording medium that stores therein a computer program product, which, when executed by a processor, causes the scheduling method disclosed herein to be performed.

Preferred embodiments of the invention are defined in the dependent claims. It shall be understood that the claimed methods, processor, computer program and medium have similar and/or identical preferred embodiments as the claimed scheduling device and as defined in the dependent claims.

The present invention is based on the idea to make use of patient-accessible devices for monitoring purposes, i.e. devices that are in possession or reach of the patient and are used by the user from time to time (regularly or at irregular times) or, in other words, devices that are accessible by the patient and that can access/track/monitor the patient. Many patient-accessible devices used in everyday life already today have the ability to acquire data (also called monitoring data herein) that are required or useful for diagnostics, e.g. for (directly or indirectly) measuring a vital sign of the patient such as the heart rate or breathing rate. For instance, sport watches have pulse rate sensors built in and smartphones. To give another example, many smartphones and tablets have a camera built in that can be used for acquiring images of the patient, which can be used to obtain vital signs from camera images of the patient using remote photoplethysmography technology as e.g. described in Verkruysse et al., “Remote plethysmographic imaging using ambient light”, Optics Express, 16(26), 22 Dec. 2008, pp. 21434-21445. Further, many patient-accessible devices may be equipped with additional sensors or other means to acquire data related to diagnostics, i.e. required by or useful for diagnostics. For instance, patient-accessible devices used in everyday life like a remote control, a computer mouse or a mobile phone may be easily equipped with a pulse rate sensor or a breath analysis chip.

According to the present invention the usage habits of the patient with respect to his patient-accessible devices are tracked. Available patient-accessible devices (also called diagnostic-enabled devices) are used for data acquisition in predetermined monitoring time windows during which the respective diagnostics require such a data acquisition. Thus, the data acquisition does not require extra time and extra devices, but is made unobtrusively while the patient is anyhow using the respective patient-accessible device for its intrinsic purpose (e.g. while the patient is using his smartphone).

The scheduling device and the scheduling method can generally be implemented on various platforms, including patient-accessible devices, dedicated scheduling hardware, dedicated software on a computer, processor, tablet or smartphone or in the cloud, a tele-monitoring station. The patient-accessible devices may comprise, but are not limited to, one or more of a smartphone, a medical device, a tablet, a remote control, a telephone, a keyboard, a camera, a motion sensor, a microphone, a user interface, a button, a proximity sensor.

In an embodiment said controller is configured to control a patient-accessible device to acquire data, if said data have not yet been acquired during the present monitoring time window and/or if higher-quality data are expected to be acquired than already acquired data. Thus, the scheduling device is not only bound to schedule data acquisition in the predetermined time windows, but performs additional checks if data have been acquired at all or if the quality of the data can even be improved (by the same or a different patient-accessible device). If higher-quality data may be acquired by a different measurement may e.g. be determined based on an estimation of the availability of other patient-accessible devices or of less disturbances in the environment or may be based on a check of the quality (e.g. the SNR) of the acquired data.

In another improvement said controller is configured to activate a patient-accessible device and to acquire data after it has become active, if said data have not yet been acquired during the last or present monitoring time window. For instance, the patient's smartphone may be activated to indicate a call or to actually give the patient a call so that the user takes the smartphone into his hands, at which moment the required data are acquired. This avoids that no data are acquired at all for a longer period although the diagnostics require said data.

Preferably, the scheduling device further comprises

a patient data interface for receiving patient data, in particular from medical health records and databases,

a monitoring needs determining unit for determining monitoring needs of the patient from the received patient data, and

a diagnostics needs determining unit for determining diagnostics associated with the determined monitoring needs, said diagnostics being provided to said diagnostics input.

Thus, the required diagnostics are not simply provided as input to the scheduling device, but are actually determined by the scheduling device based on patient data and monitoring needs retrieved from said patient data.

In a further improvement, said diagnostics needs determining unit is configured to determine one or more of the data to be acquired, the required monitoring accuracy, the monitoring frequency, allowable deviations from the monitoring time window. These data can be used for further improving the requirements of the scheduled patient monitoring.

In another improvement said monitoring needs determining unit is configured to determine and categorize monitoring needs as primary monitoring needs including the patient' current conditions, and secondary monitoring needs including risks. The monitoring data is collected and either itself triggers alarms/actions or is passed to an assessor who checks the data.

In a preferred embodiment said device identification unit is configured to determine properties and/or capabilities of identified patient-accessible devices with respect to the acquisition of data required by or useful for the diagnostics and to rank identified patient-accessible devices according to one or more of their properties, capabilities, proximity, usage duration, usage time, quality of data acquisition, ownership, sensitivity. The information used for making such a ranking is preferably obtained by determining properties and/or capabilities of identified patient-accessible devices by accessing a device database or look-up table or device specifications. For instance, the patient may keep a database or a like to a database (e.g. provided by the manufacturer or seller) holding properties and/or capabilities of his patient-accessible devices, which may then be accessed by the device identification unit.

Preferably, said controller is configured to select available patient-accessible devices for data acquisition according to their ranking and/or to select and/or weight data acquired by several patient-accessible devices according to the ranking of the respective patient-accessible devices used for acquiring said data. In this way the accuracy and reliability of the result of the data acquisition can be improved.

Advantageously, said controller is configured to arbitrate between diagnostic quality and the probability that a higher-quality patient-accessible device will be available for data acquisition during the current monitoring time window. Quality is e.g. a property of the acquisition device (sample rate, resolution, etc.) or a function of its ability to acquire good quality signals (proximity to patient, etc.). This embodiment may further lead to optimized data acquisition and results of the diagnostics.

Still further, in an embodiment the scheduling device further comprises a disturbance detector for evaluating data acquired by patient-related devices to determine if an activity and/or scenario exists that may have disturbed the acquisition of data required by or useful for diagnostics, wherein said controller is configured to release a warning to the patient or a caregiver, to initiate a repetition of data acquisition, to disregard acquired data and/or to weigh acquired data accordingly, if the existence of an activity and/or scenario exists that may have disturbed the acquisition of data required by or useful for diagnostics. Hence, external influences in the environment of the patient-accessible device used for data acquisition, which may negatively affect the acquired data, can be taken into account.

Preferably, the scheduling device and method determine the best patient-accessible device to use for data acquisition, i.e. the inputs to the subsequent data processing for obtaining diagnostic results are optimized.

### BRIEF DESCRIPTION OF THE DRAWINGS

These and other aspects of the invention will be apparent from and elucidated with reference to the embodiment(s) described hereinafter. In the following drawings

FIG. 1 shows a schematic diagram of a system for patient monitoring according to the present invention,

FIG. 2 shows a schematic diagram of first embodiment of the scheduling device according to the present invention,

FIG. 3 shows a schematic diagram of second embodiment of the scheduling device according to the present invention,

FIG. 4 shows a schematic diagram of a scheduling method according to the present invention, and

FIG. 5 shows a diagram of the labeling of current conditions and risks.

### DETAILED DESCRIPTION OF THE INVENTION

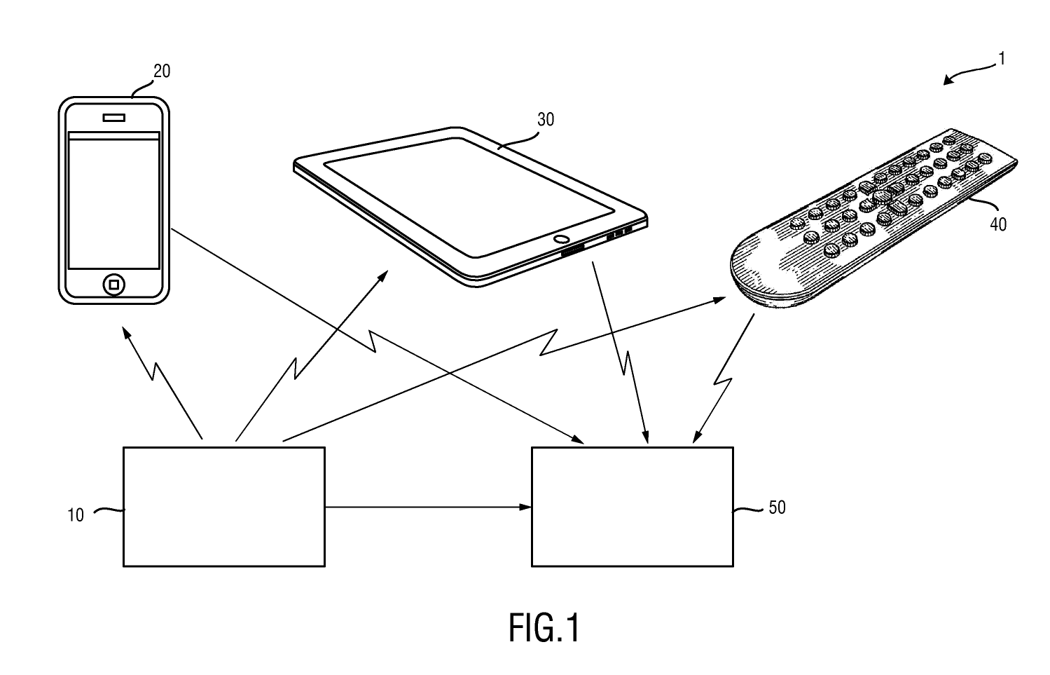

FIG. 1 shows a schematic diagram of a system 1 for patient monitoring according to the present invention. The system comprises a scheduling device 10 for scheduling patient monitoring by patient-accessible devices, one or more patient-accessible devices 20, 30, 40 for acquiring data related to diagnostics required for patient monitoring as scheduled by said scheduling device 10, and a data processor 50 for processing data acquired by said one or more patient-accessible devices 20, 30, 40.

The components of the system 1 are able to communicate with each other. In particular, the scheduling device 10 is able to communicate with the patient-accessible devices 20, 30, 40 to schedule and control them to acquire data related to diagnostics, and the patient-accessible devices 20, 30, 40 are able to communicate with the data processor 50 to deliver the acquired data to the data processor 50 for processing. Optionally, the scheduling device 10 and the data processor 50 can also communicate with each other, for instance to provide a feedback from the data processor 50 to the scheduling device 10 if the acquired data and/or the processed result are useful and/or have sufficient quality or if the data acquisition should be continued or repeated.

The technology used for the communication is irrelevant for the present invention. Wired communication (e.g. via LAN, powerline communication, direct wired connection, etc.) or wireless communication (e.g. via Bluetooth, Zigbee, WLAN, UMTS, LTE, etc.) may be used, wherein the different communication paths can be implemented in the same or in different ways. Preferably, communication means already available in a respective component, e.g. a Bluetooth transmitter and receiver available in a patient-accessible device 20 (e.g. a smartphone) or a WLAN transmitter and receiver available in another patient-accessible device 30 (e.g. a tablet) may be used, wherein the scheduling device 10 and the data processor 50 are equipped with corresponding means.

The scheduling device 10 and/or the data processor 50 may be comprised in one or multiple digital or analog processors depending on how and where the invention is applied. The different units may completely or partly be implemented in software and carried out on a personal computer or processor. Some or all of the required functionality may also be implemented in hardware, e.g. in an application specific integrated circuit (ASIC) or in a field programmable gate array (FPGA).

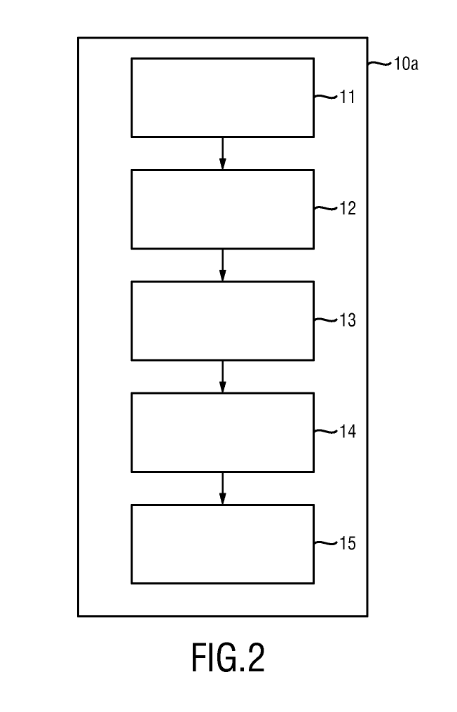

FIG. 2 shows a schematic diagram of first embodiment of the scheduling device 10a according to the present invention. It comprises a diagnostics input 11 for receiving diagnostics including a monitoring time window for acquiring data related to the diagnostics, a device identification unit 12 for identifying patient-accessible devices that can be used for acquiring data related to the diagnostics, a tracking unit 13 for tracking one or more identified patient-accessible device(s) to identify its (their) usage, a correlation unit 14 for correlating the identified usage of an identified patient-accessible device with the monitoring time window of the diagnostics, and a controller 15 for checking, during a monitoring time window, availability of identified patient-accessible devices for data acquisition and for controlling available patient-accessible devices to acquire data related to the diagnostics during said monitoring time window.

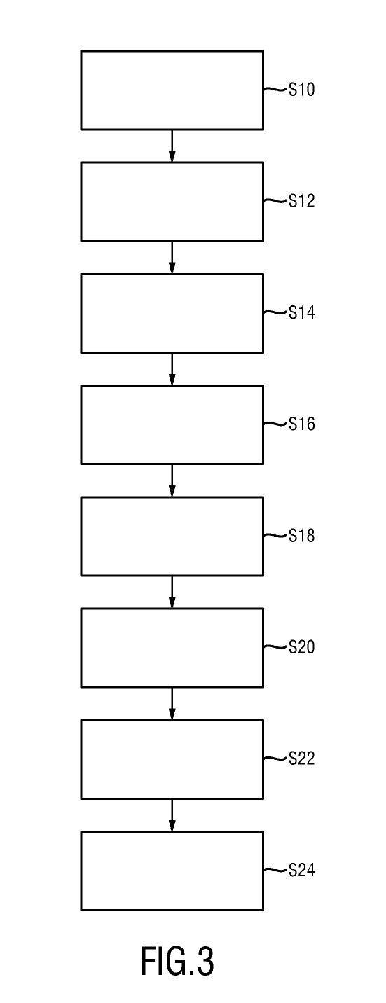

FIG. 3 shows a schematic diagram of second embodiment of the scheduling device 10b according to the present invention. It comprises a user interface 21, e.g. a keyboard, a scanner or a touchpad, for entering patient data, bar codes and/or reference numbers that can be used to access medical records of the patient. A communication means 22, e.g. a LAN interface, a WLAN interface or a Bluetooth transceiver, is provided for accessing medical records and medical databases and for communicating with patient-accessible (networked) devices. A processor 23 is provided, said processor 23 running an algorithm to determine the necessary monitoring and time window, to action samples and to arbitrate between duplicate data as will be explained in more detail below.

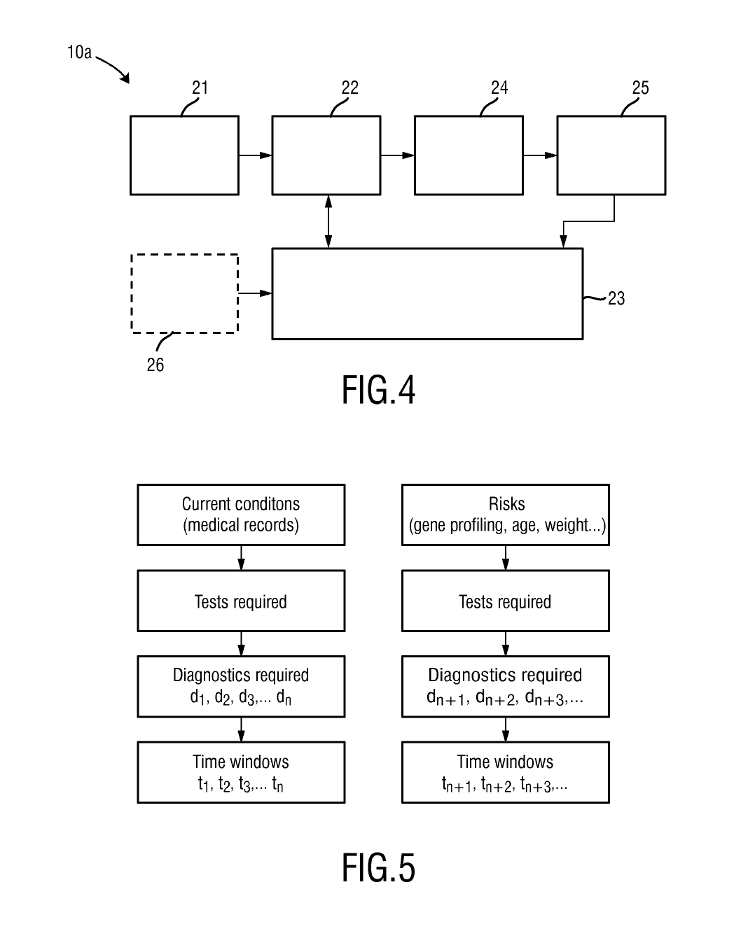

An embodiment of the general process as performed by the processor is depicted in FIG. 4 and is as follows.

In a first step S10 patient conditions and risks are determined from medical records and databases, i.e. from patient data received by the user interface 21 of the scheduling device 10, in particular from medical health records and databases. These patient conditions and risks are categorized as either (i) primary monitoring needs (the ‘current conditions’) or (ii) secondary monitoring needs, being those associated with conditions that have a high risk of affecting the patient (the ‘associated conditions’). A corresponding monitoring needs determining unit 24 for determining monitoring needs of the patient from the received patient data may be provided in the scheduling device 10b. Examples of how this can be done include:

a. A medical expert reviewing the patient's medical condition and history and manually categorizing the current conditions, and then using expertise to assess the risk of other conditions also affecting the patient in the future, and thus determining the associated conditions.
b. An algorithm provided for
i. Assessing the patient's health record and/or a statement provided by the patient's doctor via semantic processing and determining the conditions the patient is suffering from, thus determining the current conditions.
ii. Then accessing a lookup table (the ‘associated conditions LUT’) detailing various conditions that are associated with each condition, together with criteria that indicate the risk of this condition occurring.
iii. An example is a current condition of Obstructive Sleep Apnea (OSA), being determined from semantic mining of a statement of the patient's doctor. The associated conditions LUT has a list of conditions that are connected to OSA, for example type-2 diabetes, dementia and cardiovascular disease.
iv. The associated conditions LUT would have a list of criteria that gives information as to the risk of the patient also being affected by the associated condition, for example there is a higher risk that type-2 diabetes affects an OSA patient if they were also over-weight. These risk parameters are semantically determined from the patient's medical information, and through use of thresholds the associated condition is deemed as requiring ongoing monitoring or not.

In a second step S12 diagnostics associated with primary and secondary monitoring needs are determined, e.g. by a diagnostics needs determining unit 25 for determining diagnostics associated with the determined monitoring needs. A lookup table ‘Condition Monitoring Requirements LUT’ is used to associate both conditions (both current conditions and associated conditions) with monitoring requirements. An example of how this might be done would be as follows, for each condition the monitoring requirements LUT states:

i. The signals to be measured (e.g. weight, heart rate, blood pressured, stillness of hand etc.).
ii. The monitoring accuracy required (e.g. tolerance of weight allowable, tolerance of blood pressure etc.).
iii. Monitoring frequency, i.e. the number of times the signal is to be measured per day, which may be used to determine the time at which the monitoring should take place (i.e. the monitoring time window). Alternative ways to achieve this include the explicit statement of the ideal monitoring times.
iv. Allowable deviation from the monitoring times determined in step iii. (i.e. if a signal should ideally be measured at 2 pm a tolerance of 40 minutes either side may be allowable). The above example uses the monitoring requirements LUT, which is envisaged to be a generic resource used across many patients. In another embodiment the capability for a medical professional to over-ride this information and enter data specific to the patient in question is given.

In a third step S14 it is determined which patient-accessible devices may be used to take samples, for example smartphone, dedicated medical devices, tablet, TV remote control, etc. The scheduling device 10b thus has access to an inventory of devices owned and used by the patient. This might be an inventory specifically created for this purpose. Alternatively or additionally the scheduling device 10b has access to a more general ‘Home Inventory’ database (an example of which is ‘Know Your Stuff’®). This provides the device type, revision number, etc. In another embodiment the scheduling device 10b has access to a lookup table listing device capabilities (the ‘device capability LUT’). For each device this would provide information such as the sensors present in the device, the measurement signals that could be obtained from the sensors present in the device, the accuracy of those sensors, and/or the connectivity of those devices, etc. Examples of how the information in the device capability LUT could be compiled include (i) manual entry of data, (ii) using an algorithm to analyze datasheets or web sites in order to mine the required information, or (iii) the device manufacturers producing information in a format that can be readily added to the database.

In a fourth step S16 the device capability LUT and monitoring requirements LUT are compared to create a list of devices that are able to provide the data required for the monitoring of the patient. This list potentially contains multiple devices capable of collecting some of the required measurements.

In a fifth step S18 a database (the ‘device usage database’) is created containing information about how each device is used. Information that might be added to this database includes how often the device is used by the patient, how often the device is used by other people, and/or where the device is usually kept (or alternatively the usual proximity of the device to the patient). This information may be added to the device usage database manually, or in the case of devices which sufficient capability, this information might be added using information received directly from the device.

In a sixth step S20 an algorithm is then used to rank devices based on information from the device capability LUT and the device usage database together with the requirements of the monitoring requirements LUT. An example of how this might be done is:

a. Dismiss devices not capable of meeting the requirements associated with the condition in the monitoring requirements LUT;
b. Determine a ‘sole usership factor’ (SUF) between 1 and 10 indicating the percentage of time the device is used by the patient versus others (e.g. 1 being mostly used by others, 10 being only used by the patient);
c. Determine a ‘frequency of use factor’ (FOUF) between 1 and 10 (e.g. 1 being infrequent use, 10 being very frequent use);
d. Determine an ‘accuracy factor’ (AF) between 1 and 20 (e.g. 1 indicating low accuracy, 20 indicating very high accuracy); and
e. Calculate the product P=SUF*FOUF*AF, and rank the results with higher P being more preferable.

In a seventh step S22, when a diagnostic-enabled device is found in use data are acquired, if not already taken during the monitoring time window. At the end of the monitoring time window it is arbitrated between the data based on the device ranking and/or the quality of data. Alternatively or additionally, the likelihood of collecting higher-quality data during the monitoring time window considered, and data are taken accordingly, as in the following example.

In an embodiment of this step, from the results of the previous steps a schedule is created with a list of the signals to be collected, and for each signal an ideal time for the signal to be measured, and a monitoring time window, i.e. a number of minutes before and after the ideal time during which it is acceptable to collect the data representing each signal. Using this data, at any given point in time, each monitoring signal can be categorized as being in one of the four following states:

i. State 1: Not currently required (i.e. the current time does not fall within the measurement's ‘time window’.
ii. State 2: Currently required (i.e. the current time does fall within the measurement's time window), and a measurement has already been taken by at least one device that does not have the highest P ranking taking the ranked results produced for the product P.
iii. State 3: Currently required, and no measurement has been taken by any device.
iv. State 4: Currently required, and has been measured by the device with the highest P ranking.

In an eighth step S24, if a monitoring time window ends with primary-list monitoring outstanding, the data are obtained by activating the required device to demand user-response, e.g. call a smartphone and play a message whilst the sample is being taken.

In an embodiment of this step, when a patient-accessible (diagnostic-enabled) device is found in use it is, as one alternative, checked to see if any of the signals that can be provided by this device can be used to provide monitoring data. If so, the state of that monitoring data is checked. If the monitoring data are in State 2 or State 3, these data are collected. If the monitoring data are in State 1 or State 4, these data are not collected. In another alternative, it is checked to see if any of the signals that can be provided by this device can be used to provide monitoring data. These data are collected irrespective of the State. At the end of a given period (for example each day) for each monitoring data the source with the highest accuracy factor are selected and kept, disregarding the other data. An example of collecting data based on quality shall now be explained. When a diagnostic-enabled device, (Diagnostic-Enabled Device Use—DEDU), is found in use its quality ranking is checked against other diagnostic-enabled devices (Diagnostic-Enabled Device Other—DEDO) which are in proximity to the patient and can take a measurement. Further:

i. if there is a DEDO which can provide higher quality results that the DEDU, then switch to use the DEDO as the source of data, or
ii. if the DEDO will not provide higher quality results that the DEDU, then retain the DEDU as the source of data, or
iii. if the data from one or more DEDOs may be complementary to that provided by the DEDU (as for example might be the case if they are able to collect measurements from a different point on the patient, or with a higher sampling rate but further away from the patient and therefore with more noise, then employ data fusion techniques (which will be known to those practiced in the art) to combine the results of DEDU and one or more DEDO.

In above explained step S10 patient conditions and risks are determined, i.e. the step is divided into two strands conditions and risks. The method to determine them is the same for each strand, but the conditions strand is of higher priority.

For each known condition, medical databases may be consulted to determine tests required, diagnostics to be used, and frequency at which samples should be taken (with upper and lower bounds). Alternatively, they may be entered manually by the user or medical practitioner. Diagnostics and associated time windows may be labeled as shown in FIG. 5. The output is an array of time windows, each with associated diagnostic.

The diagnostic scheduler (i.e. the scheduling device 10) communicates with other devices in the vicinity and determines the diagnostics they each have available, e.g. via a database that gives details of the device model. For instance, D1(d2, d4) means the device 1 has diagnostics 2 and 4 available. These devices may optionally be stored in memory for future use. Further, devices may be given an importance ranking based on usage, ownership, sensitivity, proximity, etc.

Preferably, the diagnostic scheduler has a timer. During each time window the scheduler searches for devices with the required diagnostic capability, ranks the devices and scrolls through checking use status. When a device with the diagnostic is found in use, the processor either (i) takes data and arbitrates by data quality later or (ii) arbitrates between the diagnostic quality and the probability that a higher-quality device will be used later in the time window. The diagnostic scheduler controls the diagnostic-enabled device to take the reading when appropriate (as explained above). If at the end of the time window the diagnostic action has not been performed, the top-ranked device may be triggered for use.

Generally, only one reading is taken during the time window (the diagnostic scheduler stops looking for the relevant devices once the data has been taken). Optionally, the diagnostic scheduler could be set to arbitrate and take readings from multiple duplicate-diagnostic devices (if they were in use) as discussed above. This enables higher-ranked device data to be recorded even if the device was not the first to be controlled to take the data. Duplicate data—if taken—should be retained and used for calibration in case there are small differences in the sensors. Another optional feature is that the patient may choose to block certain devices, for example those where the patient is not the sole user, preferring to be interrupted to take readings occasionally.

Next, some practical example shall be given.

In a first example, patient A has a condition that requires her blood pressure to be monitored daily. Most days she wears a smart watch that contains a CMOS sensor. The diagnostic scheduler communicates with this diagnostic-enabled device and takes the blood pressure readings at the correct time, outputting the data to the patient's records for review by her practitioner. Some days later, patient A forgets to put on her smart watch, but there is also a CMOS blood pressure sensor in her smartphone, the TV remote and her computer mouse. During the time window for monitoring, the diagnostic scheduler communicates with each of these devices in turn. The computer mouse is found in use and the measurement is taken.

In another example, patient B suffers from asthma and requires regular breath monitoring to check the concentration of exhaled trace gas chemicals in his breath. There is a sensor chip in his mobile phone that can perform this test. The diagnostic scheduler monitors usage of the mobile phone during the time window when the breath should be monitored and takes the measurement when the phone is in use. Over the weekend Patient B does not use is mobile phone so much and often the end of time window is reached without a measurement being taken. In this case the diagnostic scheduler instructs the mobile phone to ring and the measurement is taken when Patient B answers.

As telemedicine increases more testing will be done remotely with none, or limited doctor supervision. This lack of supervision will likely bring some spurious measurement as the user may include some discrepancies without knowledge. The current trend of ‘life logging’ or ‘self-monitoring’ means that large amounts of person physiological data is available. The same holds for smartphones and environmental data. In order to increase the detection of ‘noise factors’ (disturbances) that may degrade remote measurements it is proposed in an embodiment to connect to health-monitoring devices and smartphones to gather physiological and environmental data over time. For instance, a disturbance detector 19 for evaluating data acquired by patient-related devices to determine if an activity and/or scenario exists that may have disturbed the acquisition of data related to diagnostics may be provided in the scheduling device 10b. Prior to a test an activities database is queried for activities/scenarios that could alter the test results, and an action is carried out.

A corresponding system preferably comprises a telehealth test equipment, a monitoring device and/or a smartphone, and an activities database. A superset of activities that may affect a person's telehealth regime is generally known. Various devices monitor the person and look for signatures of these activities/scenarios. When an activity/scenario is detected it is stored in the activities database.

Later, a test is initiated by the test equipment. Further, a list of activities that may affect the test results is known and this list is used to query the activities database. If a match is found, an alert is shown to the user and/or information is appended to the test results send to the doctor.

An example of where such a concept may be used is given in the reference “Yoga lowers blood pressure while cell phone use raises it” (currently disclosed at http://in.lifestyle.yahoo.com/yoga-lowers-blood-pressure-while-cell-phone-raises-061215104.html) and “Talking on a mobile phone can give you high blood pressure due to the stress it can cause” (currently disclosed at http://www.dailymail.co.uk/health/article-2325652/Talking-mobile-phone-high-blood-pressure-stress-cause.html).

In the first example, if blood pressure was being measured when someone was undergoing an atypical activity (in this case yoga) then the result may not be representative of the patient's normal activity (i.e. not doing yoga). The second example can be considered where the measurement device is the cellphone, and if the person's blood pressure is higher when he uses the cellphone (irrespective of whether a measurement is taking place or not) then again the data would be biased. The activities database then comprises a list of activities (e.g. talking on a cellphone), a list of measurements, parameters etc. that give an indication that the activity is taking place (e.g. parameters can be obtained from the cellphone to say when it is use for voice calls or not) and any thresholds and data that indicate whether the measurement period should be disqualified or not (e.g. the prior measurement may be disqualified if the call is over a certain length, or to certain people etc.). This information is then used to judge whether the measurement data should be used or not.

In a first practical example a blood pressure measurement is required. However, as this is taken, sensor data shows a television is on close by, thus possible altering the results. An alert suggests the patient re-takes the test, and if this is not done (or the same result is achieved) the information is appended to the test as it is sent to the doctor.

The proximity of the TV could e.g. be determined by a proximity sensor located in the TV. This proximity sensor could be a basic one, for example current smartphones measure the proximity of objects to the smartphone and use this information to turn off the screen (to save battery power) when the phone is being held to the ear during a phone conversation. Further, a 3D sensor that can map objects and motion within a 3D space may be used as proximity sensor. Further, the program that is on TV could be determined using a program recognition technology based on video and/or audio data, such as the smartphone app ‘Shazam’, which is e.g. able to match songs being sensed by a smartphones microphone with a catalogue of songs.

In another practical embodiment, a doctor has advised a patient to change his diet to reduce blood pressure. This is only partially done, however the patient also enrolls in a yoga course. Blood pressure is lowered, however data analysis shows that yoga is often only a short term endeavor, and should it stop the only-partial diet change may not have the desired effect. Using this information the doctor is better able to advise the patient.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A scheduling device for scheduling patient monitoring by patient-accessible devices that are in the possession or reach of the patient for use by said patient, wherein said patient-accessible devices are configured to acquire data required by or useful for a diagnostics, said scheduling device comprising:
a diagnostics input for receiving diagnostics, said diagnostics input including a monitoring time window for acquiring data required by or useful for the diagnostics,
a device identification unit for identifying patient-accessible devices suitable for acquiring data required by or useful for the diagnostics,
a tracking unit for tracking one or more of the identified patient-accessible devices to identify their usage,
a controller for checking, during said monitoring time window, availability of identified patient-accessible devices for data acquisition,
wherein the device identification unit is further configured for ranking the one or more identified patient-accessible devices based on their identified usage, and the controller is further configured for controlling available patient-accessible devices to acquire data required by or useful for the diagnostics during said monitoring time window according to their ranking.

2. The scheduling device as claimed in claim 1,
wherein said controller is configured to control a patient-accessible device to acquire data, if said data have not yet been acquired during a current monitoring time window and/or if higher-quality data are expected to be acquired than already acquired data.

3. The scheduling device as claimed in claim 1,
wherein said controller is configured to activate a patient-accessible device and to acquire data after it has become active, if said data have not yet been acquired during a previous or the current monitoring time window.

4. The scheduling device as claimed in claim 1, further comprising
a patient data interface for receiving patient data, in particular from medical health records and databases,
a monitoring needs determining unit for determining monitoring needs of the patient from the received patient data and received information from a first lookup table, and
a diagnostics needs determining unit for determining diagnostics associated with the determined monitoring needs based on received information from a second lookup table, said diagnostics being provided to the diagnostics input.

5. The scheduling device as claimed in claim 4,
wherein said diagnostics needs determining unit is configured to determine one or more of the data to be acquired, the required monitoring accuracy, the monitoring frequency, allowable deviations from the monitoring time window.

6. The scheduling device as claimed in claim 4,
wherein said monitoring needs determining unit is configured to determine and categorize monitoring needs as primary monitoring needs including the patient′ current conditions and secondary monitoring needs including risks.

7. The scheduling device as claimed in claim 1,
wherein said device identification unit is configured to determine properties and/or capabilities of identified patient-accessible devices with respect to the acquisition of data required by or useful for the diagnostics and to rank identified patient-accessible devices according to one or more of their properties, capabilities, proximity, usage duration, usage time, quality of data acquisition, ownership, sensitivity.

8. The scheduling device as claimed in claim 7,
wherein said device identification unit is configured to determine properties and/or capabilities of identified patient-accessible devices by accessing a device database or look-up table or device specifications.

9. The scheduling device as claimed in claim 7,
wherein said controller is configured to select available patient-accessible devices for data acquisition according to their ranking and/or to select and/or weight data acquired by several patient-accessible devices according to the ranking of the respective devices used for acquiring said data.

10. The scheduling device as claimed in claim 7,
wherein said controller comprises an algorithm configured to arbitrate between diagnostic quality and the probability that a higher-quality device will be available for data acquisition during the current monitoring time window.

11. The scheduling device as claimed in claim 1,
further comprising a disturbance detector for evaluating data acquired by patient-related devices to determine if an activity and/or scenario exists that may have disturbed the acquisition of data required by or useful for diagnostics based on detected activities/scenarios from an activities database,
wherein the controller is configured to release a warning to the patient or a caregiver, to initiate a repetition of data acquisition, to disregard acquired data and/or to weigh acquired data accordingly, if the existence of an activity and/or scenario exists that may have disturbed the acquisition of data required by or useful for diagnostics.

12. A method for scheduling patient monitoring by patient-accessible devices that are in the possession or reach of the patient for use by the patient, wherein said patient-accessible devices are configured to acquire data required by or useful for a diagnostics, said method comprising
receiving diagnostics including a monitoring time window for acquiring data required by or useful for the diagnostics,
identifying patient-accessible devices suitable for acquiring data required by or useful for the diagnostics,
tracking one or more of the identified patient-accessible devices to identify their usage,
ranking the one or more identified patient-accessible devices based on their identified usage,
checking, during said monitoring time window, availability of identified patient-accessible devices for data acquisition, and
controlling available patient-accessible devices to acquire data required by or useful for the diagnostics during said monitoring time window according to their ranking.

13. Computer program comprising program code means for causing a computer to carry out the steps of the method as claimed in claim 12 when said computer program is carried out on the computer.

14. A system for patient monitoring comprising
a scheduling device as claimed in claim 1 for scheduling patient monitoring by patient-accessible devices,
one or more patient-accessible devices for acquiring data related to diagnostics required for patient monitoring as scheduled by said scheduling device, and
a data processor for processing data acquired by said one or more patient-accessible devices.

15. The system as claimed in claim 14,
wherein said patient-accessible devices comprise one or more of a smartphone, a medical device, a tablet, a remote control, a telephone, a keyboard, a camera, a motion sensor, a microphone, a user interface, a button, a proximity sensor.
